(19) United States
(12) Patent Application Publication
(10) Pub. No.: US 2019/0261273 A1
(43) Pub. Date: Aug. 22, 2019

(54) WAKE-UP RECEIVER-BASED POWER CONSUMPTION REDUCTION METHOD AND APPARATUS

(71) Applicant: LG ELECTRONICS INC., Seoul (KR)

(72) Inventors: Jeongki KIM, Seoul (KR); Kiseon RYU, Seoul (KR); Suhwook KIM, Seoul (KR); Hyunhee PARK, Seoul (KR); Hangyu CHO, Seoul (KR); Jinsoo CHOI, Seoul (KR)

(73) Assignee: LG ELECTRONICS INC., Seoul (KR)

(21) Appl. No.: 16/333,569

(22) PCT Filed: Sep. 28, 2017
(86) PCT No.: PCT/KR2017/010851

§ 371 Date: Mar. 14, 2019

Related U.S. Application Data
(60) Provisional application No. 62/400,641, filed on Sep. 28, 2016.
(60) Provisional application No. 62/426,597, filed on Nov. 28, 2016.
(60) Provisional application No. 62/430,905, filed on Dec. 6, 2016.
(60) Provisional application No. 62/492,985, filed on May 2, 2017.
(60) Provisional application No. 62/503,942, filed on May 10, 2017.
(60) Provisional application No. 62/535,971, filed on Jul. 24, 2017.

(51) Int. Cl. H04W 52/02; H04W 76/28; H04W 76/11; H04W 72/04

(52) U.S. Cl. CPC H04W 52/0229; H04W 52/0216; H04W 84/12; H04W 76/11; H04W 72/0406; H04W 76/28

(57) ABSTRACT

In a wireless local area network system (WLAN), a method and an apparatus for reducing power consumption of a station (STA) comprising a wake-up receiver (WUR) and a WLAN transmitter/receiver are disclosed. To this end, an STA receives a wake-up packet (WUP) including a group-based identifier using the WUR when the WLAN transmitter/receiver is OFF, and switches the WLAN transmitter/receiver to be ON according to WUP information so as to perform WLAN communication using the WLAN transmitter/receiver, wherein one or more of switching the WLAN transmitter/receiver to be ON, and maintaining the ON state are indicated by a traffic indication map (TIM).

### BACKGROUND OF THE INVENTION

### Field of the Invention

The present invention relates to wireless LAN systems and, more particularly, to a operating method based on Wake-Up Receiver for reducing power consumption in a wireless LAN system and an apparatus for the same.

### Related Art

The method for reducing power consumption proposed below may be applied to various wireless communications, but hereinafter, is described by considering the form applied to wireless local area network (WLAN).

In IEEE 802.11 standard, in order to lengthen the life span of a WLAN station, the power saving mechanism is provided. For the power saving, a WLAN station operates in two modes including an active mode and a sleep mode. The active mode is referred to as a state in which a normal operation is available such as frame transmission and reception, channel scanning, or the like. On the other hand, in the sleep mode, power consumption is extremely reduced and it is unavailable to perform a frame transmission and reception, and it is also unavailable to perform a channel scanning. The basic operation principle is that a WLAN station is in the sleep mode normally, but switched to the active mode only when it is required.

Since power consumption is reduced if the WLAN station may be operated for a long time if possible in the sleep mode, life span of the WLAN station is increased. However, since frame transmission and reception is impossible in the sleep mode, the WLAN station cannot be operated unconditionally for a long time in the sleep mode. If there is a frame to be transmitted in the sleep mode, since the WLAN STA is switched to the active mode to transmit the frame, there is no big problem. However, if the station is in the sleep mode and the AP has a frame to be transmitted to the station, the station cannot receive the frame and cannot know there is a frame to be received. Therefore, the station should sometimes be switched to the active mode to receive a frame if there is the frame to be received, and should be operated in a reception mode. In addition, the AP should notify the station of the presence of the frame to be transmitted to the station, at the corresponding time.

The WLAN station periodically wakes up from the sleep mode to know that there is a frame to be received, and receives a beacon frame from the AP. The AP notifies each station whether there is a frame to be received by the station, by using a TIM element of the beacon frame. The TIM element includes two types, TIM and DTIM, wherein the TIM may be used to indicate a unicast frame, and the DTIM may be used to indicate multicast/broadcast frame.

FIGS. 1 to 3 are diagrams for describing an operation according to the power consumption reduction scheme in a WLAN system.

A station knowing that an AP has a frame to send to the station itself through the TIM element of the beacon frame transmits PS-Poll frame going through contending. The AP that receives the PS-Poll frame operates by selecting Immediate Response or Deferred Response depending on a situation. According to the Immediate Response, as shown in FIG. 1, after receiving the PS-Poll frame and immediately after a next SIFS time, a data frame is transmitted. In the case that the data frame is normally received, a station transmits ACK frame after the SIFS, and is switched to the sleep mode again.

In the case that the AP is unable to prepare a data frame during the SIFS time after receiving the PS-Poll frame, the AP selects a Deferred Response. As shown in FIG. 2, the AP transmits ACK frame first, and when a data frame is prepared, transmits the data frame to the station going through contending. The station that receives the data frame successfully is switched to the sleep mode again after transmitting ACK frame.

On the other hand, since the DTIM is multicast/broadcast frame, as shown in FIG. 3, without transmitting and receiving the PS-Poll frame, the data frame transmission is continued immediately after the beacon frame, and all of the corresponding stations receive it in the active mode.

The WLAN station is allocated with an Associated ID (AID) while establishing an association with the AP. The AID is uniquely used in a single BSS, and may have a value of 1 to 2007. 14 bits are allocated for the AID, the AID is available to use maximum 16383 values, but values of 2008 to 16383 have been reserved.

### SUMMARY OF THE INVENTION

According to power consumption reduction scheme in WLAN system described above, power consumption of a station (STA) may be reduced. However, more innovatively, there is a discussion for the scheme of waking-up an STA by a signal of a separate simple method only in the case that there is data to transmit and receive, in the state of turning off WLAN communication normally.

The present invention is to provide a mechanism for such an efficient Wake-Up operation.

The present invention is not limited to the technical problem to solve described above, but other technical problems to solve may be inferred from the embodiments of the present invention.

In an aspect of the present invention, a method for reducing power consumption of a station (STA) including a Wake-Up Receiver (WUR) and a Wireless Local Area Network (WLAN) transceiver in a wireless LAN system is proposed. The method includes receiving a Wake-Up Packet (WUP) including a group-based identifier based on the WUR while the WLAN transceiver is in an OFF state; performing a WLAN communication based on the WLAN transceiver by switching the WLAN transceiver to an ON state based on information included in the WUP, wherein one or more of switching the WLAN transceiver to the ON state and keeping the WLAN transceiver in the ON state is based on Traffic Indication Map (TIM) information.

The WUP includes the TIM information in a payload field, when the STA is related to the TIM information, the STA may switch the WLAN transceiver to the ON state.

The STA switches the WLAN transceiver to the ON state based on the group-based identifier included in the WUP, the STA receives the TIM information based on the WLAN transceiver, and when the STA is not related to the TIM information, the STA may switch the WLAN transceiver to the OFF state.

The STA switches the WLAN transceiver to the ON state based on the group-based identifier included in the WUP, the STA receives the TIM based on the WLAN transceiver, and when the STA is related to the TIM information, wherein the STA may transmit a Power Save (PS)-Poll frame.

The TIM information of the WUP may include: a start Association ID (AID) field related to the AID of a first STA when AIDs of STAs that are related to the WUP are sequentially arranged; and a Partial Virtual Bitmap information including a bitmap related to a difference from the start AID when the AIDs of the STAs that are related to the WUP are sequentially arranged.

The TIM information of the WUP may include: a group ID field related to a group ID for Most Significant Bit (MSB) of the AIDs of the STAs that are related to the WUP; and a predetermined number of sub AID fields related to a remaining part of the group ID of the AIDs of the STAs that are related to the WUP

The STA may receive a frame including a Membership Status Array field related to a group to which the STA is belonged and a User Position Array field related to a position of the STA in the group from an Access Point (AP), and the STA may determine the group-based identifier based on the frame information.

Meanwhile, in another aspect of the present invention, a station (STA) for reducing power consumption in a wireless LAN system is proposed. The STA may include one or more antennas; a Wake-UP Receiver (WUR) connected to the antenna; a Wireless Local Area Network (WLAN) transceiver connected to the antenna; and a processor for controlling the WUR and the WLAN transceiver, wherein the processor is configured to: when the WLAN transceiver receives a Wake-Up Packet (WUP) including a group-based identifier based on the WUR while the WLAN transceiver is in an OFF state, perform a WLAN communication based on the WLAN transceiver by switching the WLAN transceiver to an ON state based on information included in the WUP, wherein one or more of switching the WLAN transceiver to the ON state and keeping the WLAN transceiver in the ON state is controlled based on Traffic Indication Map (TIM) information.

The TIM information is included in one of a payload field, a receiver ID or an address field and a field transmitted after the receiver ID or the address field received based on the WUR, and when the STA is related to the TIM information, the processor may switch the WLAN transceiver to the ON state.

The processor may switch the WLAN transceiver to the ON state based on the group-based identifier included in the WUP, the processor may receive the TIM information based on the WLAN transceiver, and when the STA is not related to the TIM information, the processor may switch the WLAN transceiver to the OFF state.

The processor may switch the WLAN transceiver to the ON state based on the group-based identifier included tin the WUP, the processor may receive the TIM information based on the WLAN transceiver, and when the STA is related to the TIM information, the processor may transmit a Power Save (PS)-Poll frame.

The TIM information of the WUP may include: a start Association ID (AID) field related to the AID of a first STA when AIDs of STAs to which Wake-UP is indicated are sequentially arranged; and a Partial Virtual Bitmap including a bitmap related to a difference from the start AID when the AIDs of STAs to which Wake-UP is indicated are sequentially arranged.

The TIM information of the WUP may include: a group ID field including a group ID related to Most Significant Bit (MSB) of the AIDs of STAs to which Wake-UP is indicated; and a predetermined number of sub AID fields related to a remaining part of the group ID of the AIDs of STAs to which Wake-UP is indicated.

Meanwhile, when the processor receives a frame including a Membership Status Array field related to a group to which the STA is belonged and a User Position Array field related to a position of the STA in the group from an Access Point (AP), the processor may determine the group-based identifier based on the frame information.

In another aspect of the present invention, a method for reducing power consumption of a station (STA) including a Wake-Up Receiver (WUR) and a Wireless Local Area Network (WLAN) transceiver in a wireless LAN system performed by an Access Point (AP) is proposed. The method may include transmitting a Wake-Up Packet (WUP) including a group-based identifier to the STA while the WLAN transceiver is in an OFF state; and indicating one or more of switching the WLAN transceiver to an ON state and keeping the ON state is indicated by Traffic Indication Map (TIM) information.

According to the embodiments of the present invention, power consumption of an STA may be significantly reduced through Wake-Up packet except WLAN.

In addition, according to the embodiments of the present invention, signaling overhead of Wake-Up packet may be minimized.

The technical effects in the present invention are not limited to the above-described technical effects and other technical effects which are not described herein will become apparent to those skilled in the art from the following description.

### BRIEF DESCRIPTION OF THE DRAWINGS

FIGS. 1 to 3 are diagrams for describing an operation according to the power consumption reduction scheme in a WLAN system.

FIGS. 4 and 5 are diagrams for describing WUR concept according to an embodiment of the present invention.

FIG. 6 is a diagram illustrating a structure of WUR according to an embodiment of the present invention.

FIGS. 7 to 9 are diagrams illustrating a format of WUR including TIM according to an embodiment of the present invention.

FIG. 10 is a diagram for describing an operation scheme according to a WUP including the TIM according to an embodiment of the present invention.

FIGS. 11 to 15 are diagrams for describing an example that the TIM information is included instead of the receiver address of a MAC header according to an embodiment of the present invention.

FIGS. 16 and 17 are diagrams illustrating the case that the TIM is transmitted through WLAN after receiving a WUP according to an embodiment of the present invention.

FIG. 18 is a diagram illustrating an example of receiving a Trigger frame through WLAN after receiving a WUP according to an embodiment of the present invention.

FIG. 19 is a diagram illustrating the case that TIM information and a Trigger frame are transmitted together through WLAN after receiving a WUP according to an embodiment of the present invention.

FIG. 20 is a diagram illustrating the case that Group wake-up is used when Multicast data is transmitted.

FIG. 21 illustrates an example that a WUP is transmitted using Broadcast ID according to an embodiment of the present invention.

FIG. 22 is a diagram illustrating the TIM structure according to an embodiment of the present invention.

FIG. 23 illustrates an example that a size of the Partial Virtual Bitmap is 2 bytes (16 bits) in FIG. 22.

FIGS. 24 to 27 are diagrams illustrating a size predicted in the structure of FIG. 22.

FIGS. 28 and 29 illustrate modified examples of other embodiments of the present invention.

FIG. 30 illustrates a Fixed TIM structure including 4 AIDs according to an embodiment of the present invention.

FIGS. 31 to 34 illustrate modified examples of FIG. 30.

FIG. 35 is a diagram illustrating an example that an AID is hierarchically configured according to an embodiment of the present invention.

FIG. 36 is a particular example of FIG. 35, and illustrates an example that N=4 and M=7.

FIGS. 37 and 38 illustrate an example that the TIM structure defined in FIG. 35 is shown in Group ID+sub AID form.

FIG. 39 is a diagram illustrating a membership state array field according to an embodiment of the present invention, and FIG. 40 is a diagram illustrating a user location array field.

FIGS. 41 to 43 are diagrams illustrating examples of transmitting a WUP with a Group ID and a User Position Bitmap being included according to an embodiment of the present invention.

FIGS. 44 and 45 are diagrams illustrating Group ID structures according to an embodiment of the present invention.

FIG. 46 is a diagram illustrating the case of having a Block Bitmap type according to an embodiment of the present invention.

FIGS. 47 to 49 illustrate modified examples of FIG. 46.

FIG. 50 is a diagram illustrating the case that an AID differential value is included instead of the AID according to an embodiment of the present invention.

FIG. 51 illustrates a modified example of FIG. 50.

FIG. 52 is a diagram illustrating the case that only a single AID is included in a corresponding Block according to an embodiment of the present invention.

FIG. 53 is a diagram for describing the case that one or more types are supported according to an embodiment of the present invention.

FIG. 54 is a block diagram for an exemplary configuration of an AP device (or a base station device) and an STA device (or a user equipment device) according to an embodiment of the present invention.

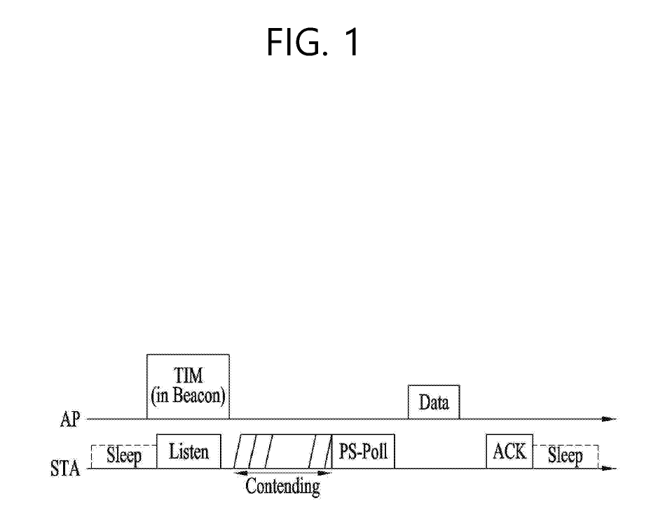

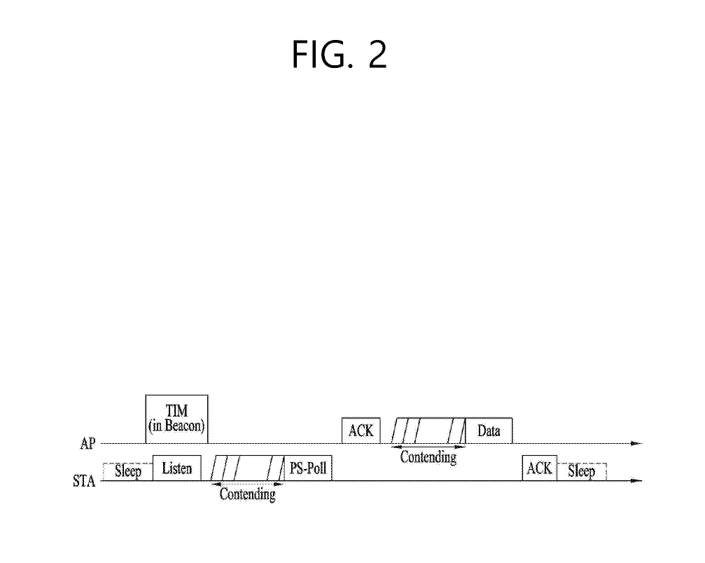

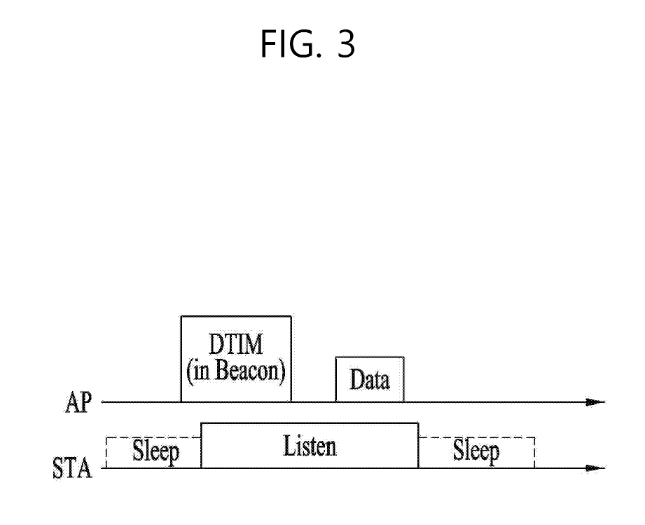

### DESCRIPTION OF EXEMPLARY EMBODIMENTS

Hereinafter, the preferred embodiment of the present invention will be described in detail with reference to the appended drawings. The detailed description that will hereinafter be disclosed along with the appended drawings will only be provided to describe an exemplary embodiment of the present invention. And, therefore, it should be understood that the exemplary embodiment presented herein will not represent the only embodiment for carrying out the present invention. The following detailed description includes specific details for providing a full understanding of the present invention. However, it will be apparent to anyone skilled in the art that the present invention can be carried out without referring to the above-mentioned specific details.

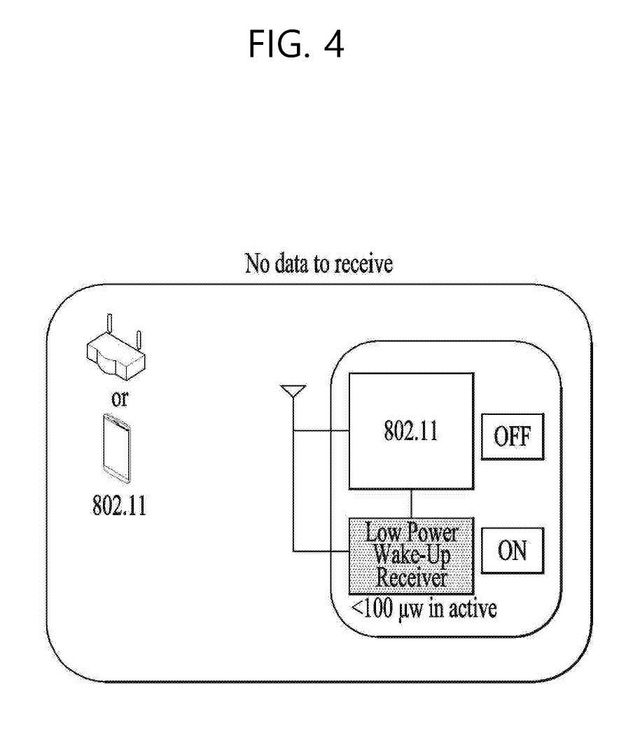

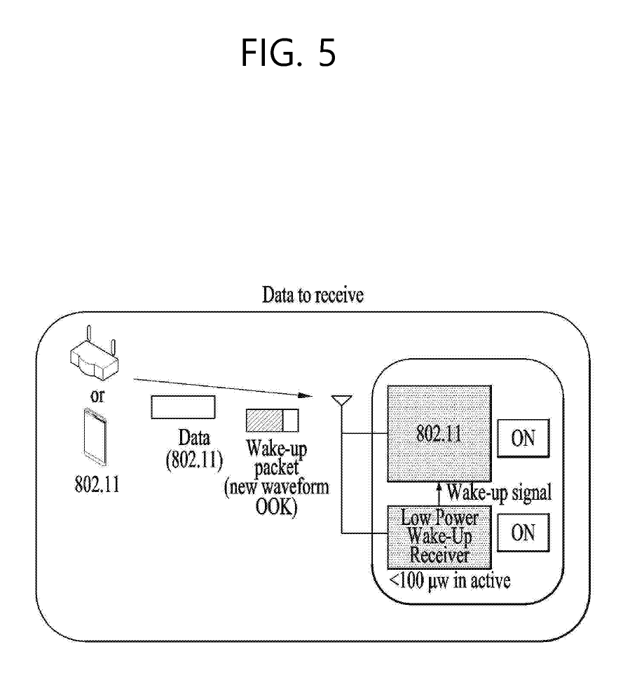

FIGS. 4 and 5 are diagrams for describing WUR concept according to an embodiment of the present invention.

As shown in FIG. 4 and FIG. 5, an STA according to this embodiment may include one or more antennas, a WLAN transceiver according to 802.11 standard and a Wake-Up Receiver (WUR). Particularly, the WLAN transceiver used for the main wireless communication may be kept as OFF state in the case that there is no data to transmit and receive, as shown in FIG. 4. Whereas the WLAN transceiver itself wakes up periodically and checks whether there is data transmitted to the WLAN transceiver itself in the conventional WLAN operation, the STA according to this embodiment may determine whether to Wake-Up WLAN by using a low power WUR, but the WLAN transceiver does not wake up periodically.

As shown in FIG. 5, in the case that there is data to be transmitted to the STA, an AP or a WUR transmitter may transmit a Wake-Up Packet (WUP) and the WUP may be received by the WUR of the STA. In the case that the WUP received by the WUR indicates that there is data to be transmitted to the corresponding STA, the STA may switch the WLAN transceiver to ON state, and perform a communication through WLAN.

It is preferable that the WUR consumes power of 100 μW or less even in the Active state, and it is also preferable to perform simple On-Off Keying (OOK) modulation. In addition, it is also preferable that a bandwidth used for WUR transmission is also 5 MHz or less.

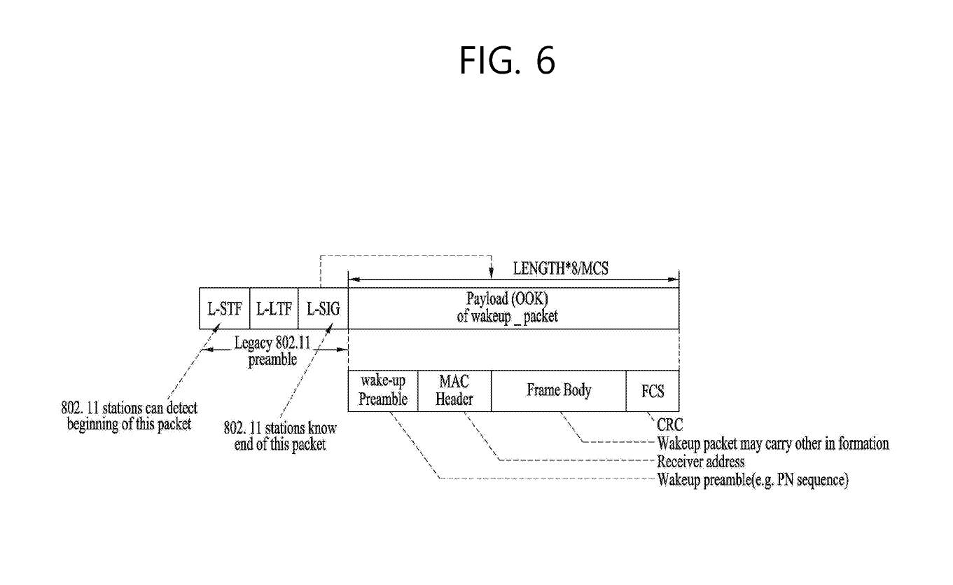

FIG. 6 is a diagram illustrating a structure of WUR according to an embodiment of the present invention.

In the example of FIG. 6, it is shown that a WUP includes a Legacy-Short Training Field (L-STF), a Legacy-Long Training Field (L-LTF), a Legacy-Signaling Field (L-SIG) and a payload field, but this is just an example, and the present invention is not limited thereto. FIG. 6 shows the example that the payload field includes a Wake-up preamble, a MAC header, a frame body and an FCS field.

It is assumed that the STA that receives a WUP may detect a starting point of the corresponding packet through the L-STF and detect an ending point of the packet through the L-SIG field.

As described above, for low power consumption of a user equipment, the user equipment may keep the WUR, and may be switched to OFF state in 802.11. When an AP receives data to transmit to a WUR STA, the AP transmits a WUR packet to a user equipment, and transmits data after waking up the user equipment. Since the WUR packet is transmitted with being encoded with OOK (low transmission rate), even small packet is transmitted for a long time. In a dense WLAN environment, a transmission of the WUR packet to an STA one-to-one manner may cause a resource waste and an inefficiency of network owing to contention increase.

Accordingly, hereinafter, a method is proposed to wake up a user equipment efficiently by using group-based method when an AP wakes up the user equipment through a WUR.

### First Embodiment—WUP Including TIM

In this embodiment, it is proposed a method for calling one or more user equipments by transmitting a Wakeup packet with Traffic Indication Bitmap (TIM) information being included. WUR STAs indicated in the corresponding TIM through the TIM information may receive a WUR packet and operate by turning on 802.11.

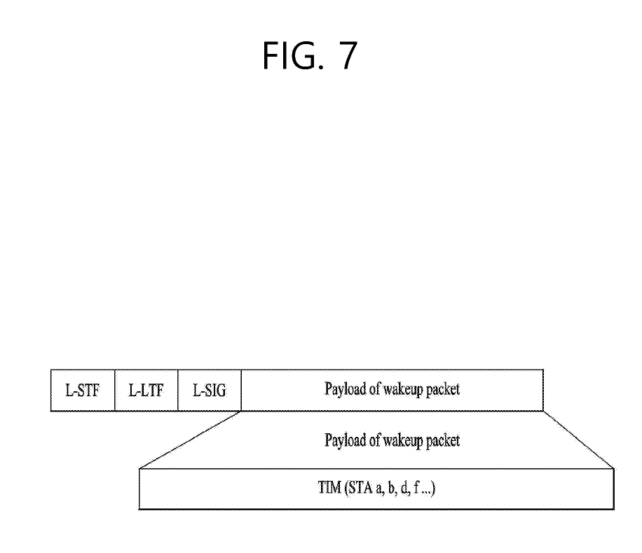

FIGS. 7 to 9 are diagrams illustrating a format of WUR including TIM according to an embodiment of the present invention.

As shown in FIG. 7, a WUP may be distinguished into a preamble part such as an L-STF, an L-LTF, an L-SIG, and the like and a payload part, and in the embodiment of FIG. 7, it is shown that the payload part includes the TIM.

For example, in the case that the TIM indicates STAs a, b, d and f, the corresponding STA may operate by switching a WLAN transceiver to ON state according to the WUR reception.

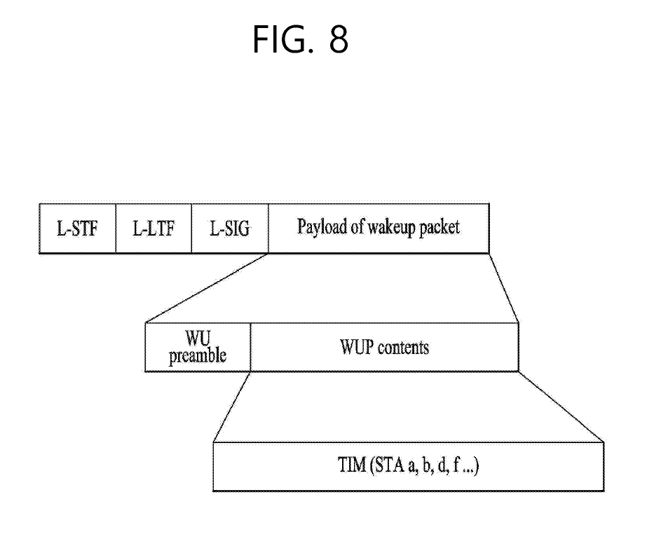

Meanwhile, Wakeup packet payload may include preamble and contents, and the TIM information may be included in the WUR contents. FIG. 8 shows an example for it.

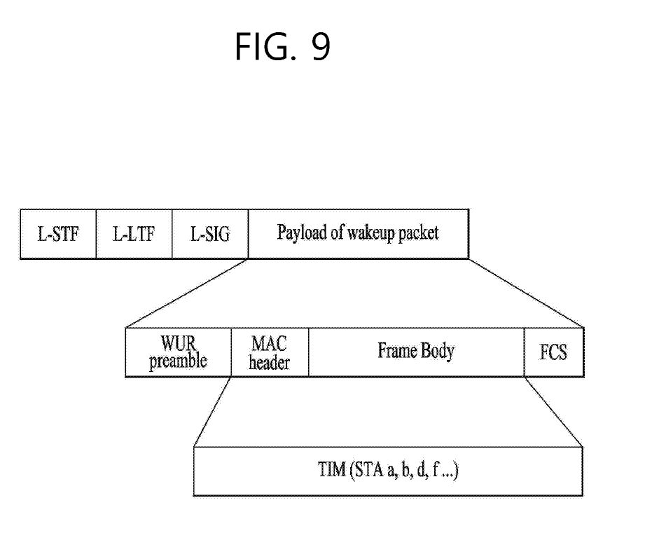

In addition, as shown in FIG. 9, the WUP contents may include MAC header Frame body and FCS, and in FIG. 9, a TIM Bitmap may be transmitted with being included in the Frame body.

In this case, a Receiver address may be included in a MAC header of a frame that carries the TIM, and in the WU Packet including the TIM, the Receiver address may have one of the following address information.

1) Broadcast MAC address (e.g., 6 bytes)

2) Multicast MAC address (e.g., 6 bytes)

3) Broadcast AID (e.g., 2 bytes or 12 bits)

4) Group(/Multicast) AID (e.g., 2 bytes or 12 bits)

In the case that the Receiver address has AID format (2 bytes or 12 bits), when transmitting the TIM information, the AID may be transmitted with being configured as 0 (Broadcast AID). In this case, since the AID is 0, all of the WUR STAs associated with the corresponding AP may check whether the information indicating the WUR STAs is included in the TIM through the TIM information included in the frame body, and determine whether to wake-up.

Alternatively, the case that the Receiver Address/ID has a single special value (e.g., Special AID value (e.g., 2047 or 2046)) indicates that the TIM is included in the WUP contents. In this case, the WUR STAs may determine whether to wake up based on the succeeding TIM information. In the case that the TIM includes the information indicating the STAs, the STAs perform the wake up procedure, and in the case that the TIM does not includes the information indicating the STAs, the STAs does not wake up but keep the WUR mode. In generalizing this, in the case that a Receiver ID includes a single special value, information for waking up a plurality of STAs may be included in the part (e.g., new field or payload part) succeeding the Receiver ID field. An example for waking up a plurality of STAs may be a Receiver ID list including the TIM Bitmap or IDs of multiple receives.

In the case that a Multicast MAC address or a Group ID is used in a Receiver address, only the STAs included in the corresponding group may decode the frame body including the TIM. The Group AID may be allocated to the STAs through an association procedure or a Group AID allocation procedure. According to the Group ID allocation procedure, a user equipment and an AP exchange a management frame after the association and a Group AID is allocated to the user equipment.

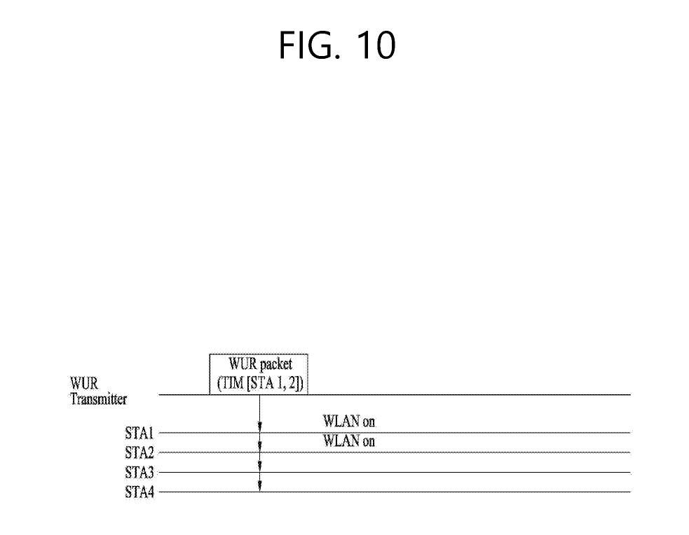

FIG. 10 is a diagram for describing an operation scheme according to a WUP including the TIM according to an embodiment of the present invention.

In the example of FIG. 10, in the TIM information of a WUR packet, STA 1 and STA 2 are indicated, and STA 1 and STA 2 that receive the WUR packet in which the TIM is included turn ON WLAN.

The TIM information included in the WUR packet defined above may be transmitted through a WUR preamble or a MAC header (i.e., control frame) except a MAC frame body.

In the case that the TIM information is included with being associated with a Group ID, the Group ID may be transmitted through the WUR preamble (e.g., SIG part in the preamble), and the TIM information may be forwarded through a receiver address part, not the frame body.

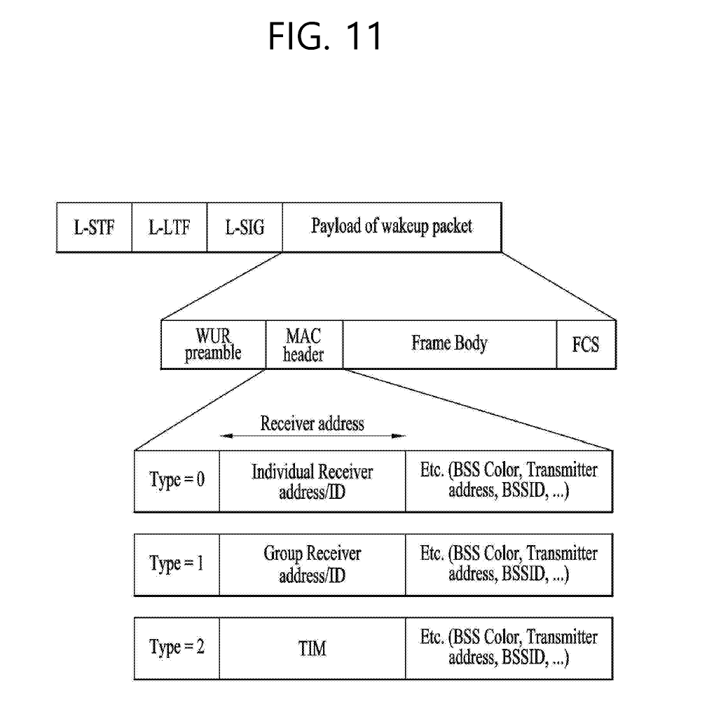

FIGS. 11 to 15 are diagrams for describing an example that the TIM information is included instead of the receiver address of a MAC header according to an embodiment of the present invention.

In the example of FIG. 11, when Type is 0, a Receiver address is transmitted with an individual receiver MAC address or an AID being included.

When Type is 1, a Receiver address is transmitted with a Group receiver MAC address, a Multicast address or a Group ID being included.

When Type is 2, a Receiver address is transmitted with the TIM information being included. That is, Type=2 indicates that the TIM is included in the WUR contents, and the Receiver ID and the TIM may be included together. The example above indicates that the TIM is included instead of the Receiver ID/address. In the case that the Receiver ID and the TIM are included together, the Receiver ID is configured as a Broadcast AID or a Special AID, and indicates that the TIM is included in the WUP contents (e.g., MAC header, Body, etc.).

When Type is 3, a Receiver address is transmitted with the Broadcast address being included. This is used when DTIM traffic or broadcast traffic is transmitted.

In the MAC header, except the receiver address information, one or more other information such as BSS color, BSSID, Transmitter MAC address, and the like may be included and transmitted. A transmitter address such as BSS color, BSSID, Transmitter MAC address, and the like may be transmitted with the frame body, instead of the MAC header being included.

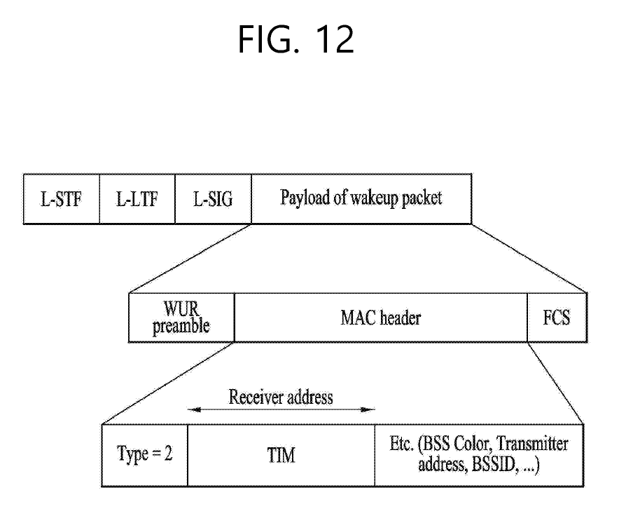

The frame body part may be omitted in the case that there is no information to be transmitted additional. FIG. 12 shows such a case.

In the example of FIG. 12, it may be configured as below according to a Frame Type.

Type=0: 48 bits MAC address is included in a Receiver address: One of an Individual address, a Multicast address and a Broadcast address is included.

Type=1: AID/WUR ID is included in a Receiver address: The AID may be one of 12 bits or 16 bits size.

Type=2: The TIM is included in the WUP contents, and the TIM may be included instead of a Receiver address.

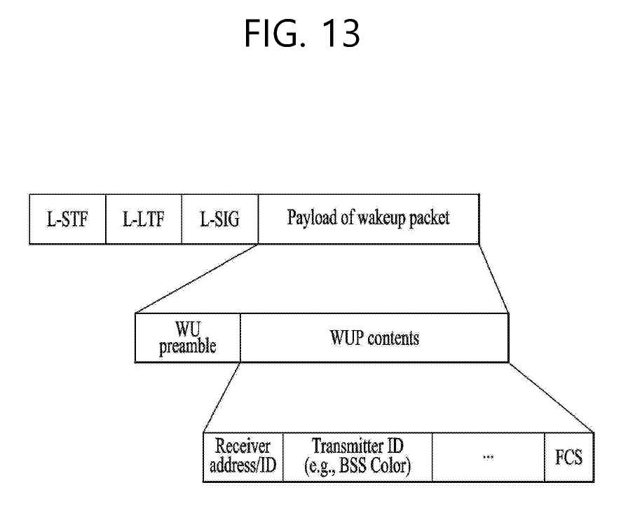

In the above example, using the term “MAC header”, the embodiment is described in which a Receiver address is included in the MAC header, but without the structure of MAC header, the Receiver address is directly included in the WUP contents, and the WUP related information may be transmitted with being included in the WUP. FIG. 13 shows such an example.

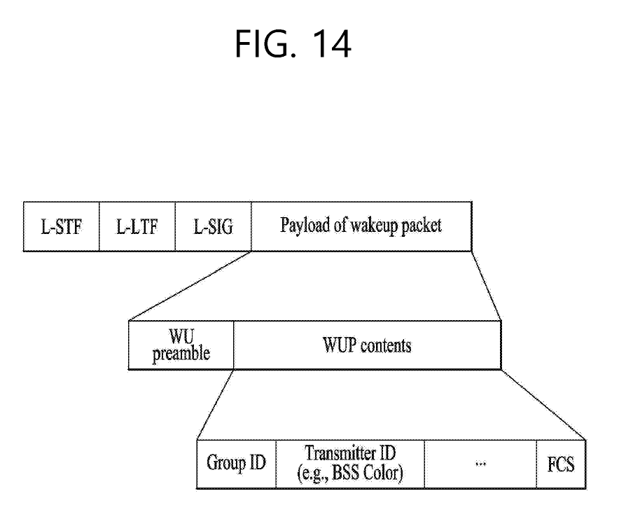

As described above, when Receiver ID=Group ID (or Broadcast ID), the TIM may be included. FIG. 14 shows such an example.

In the case that the Receiver is the Group ID, the corresponding Group ID may mean that the TIM is included in the WU packet.

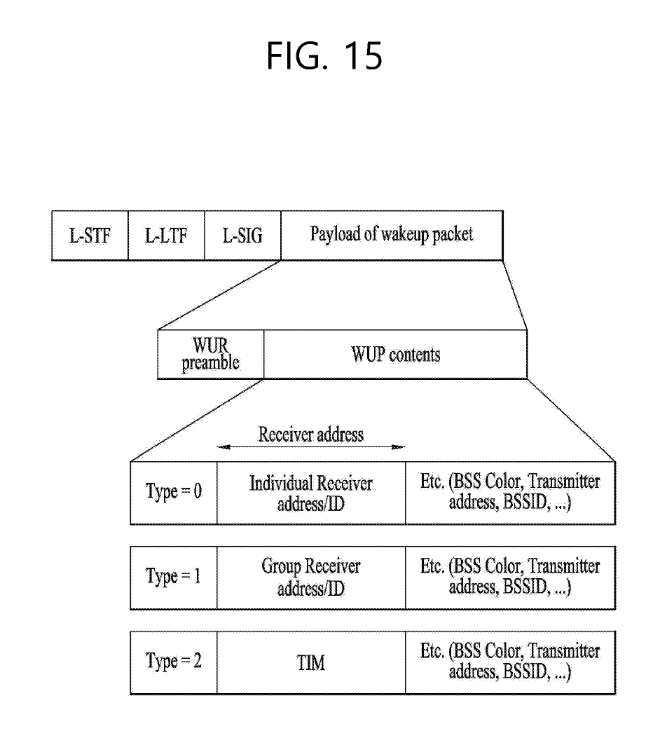

The Frame Type information described above may be included in the WUP contents, and configure other WUP format as shown in FIG. 15.

### Second Embodiment—TIM Transmission Through WLAN

In this embodiment, it is proposed that only a Group ID is included in a WUR packet and transmitted, after waking up (i.e., turn on WLAN) the WUR STAs belonged to the corresponding group, a TIM Broadcast frame or a Beacon frame including the TIM is transmitted using 802.11, and accordingly, only specific STAs are awakened among the STAs belonged to the corresponding group.

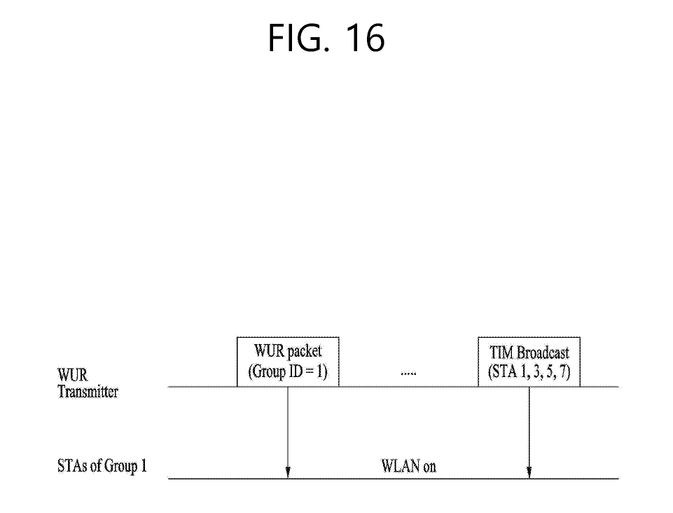

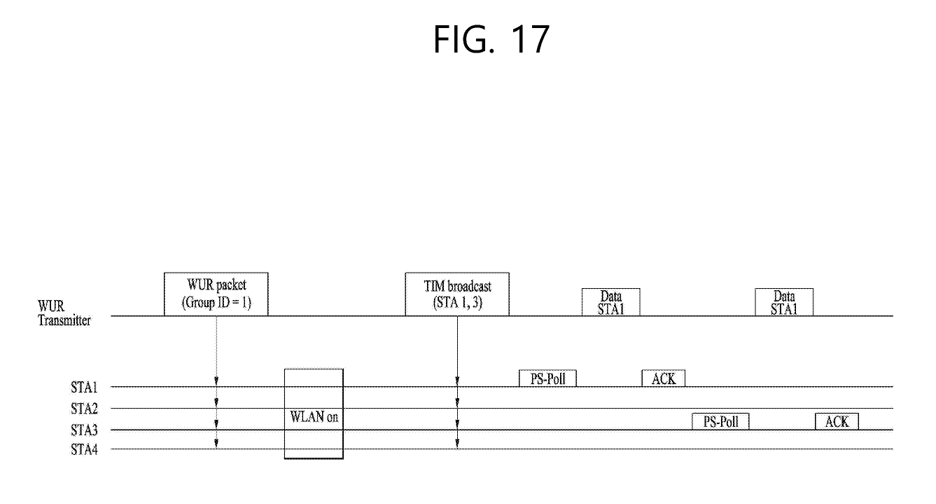

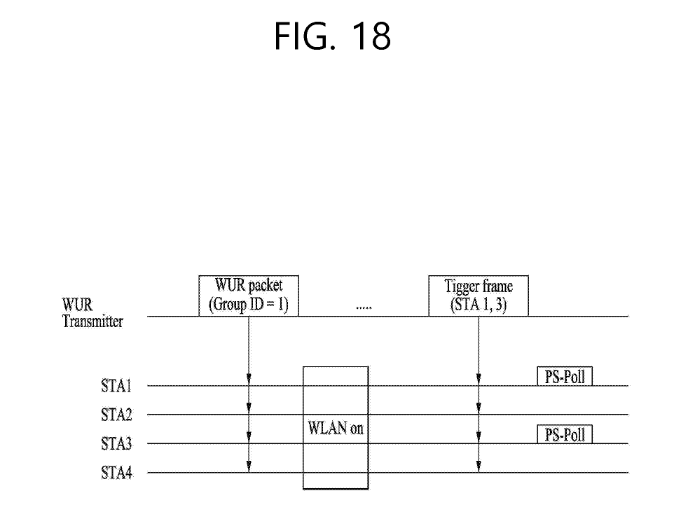

FIGS. 16 and 17 are diagrams illustrating the case that the TIM is transmitted through WLAN after receiving a WUP according to an embodiment of the present invention.

In the example of FIGS. 16 and 17, all of STAs (e.g., STAs 1 to 10) belonged to Group 1 are awakened through a WUR packet. The STAs awakened by the WUR packet receive the TIM Broadcast frame or the Beacon frame transmitted later through a WLAN transceiver, and identify that the TIM includes the data transmitted to the STAs.

The STAs (STAs 1, 3, 5 and 7 in FIG. 16) which are indicated in the TIM Broadcast frame notify that the STAs wake up to a WUR Transmitter and wait for receiving data. The STAs which are not indicated by the TIM Broadcast turn off WLAN again, and wait for a WUR reception.

In the above example, STAs 1, 2, 3 and 4 belonged to Group 1 receive the WUR packet and turn on WLAN, and identify that there is data transmitted to the STAs. Since STAs 1 and 3 are indicated by the TIM Broadcast, in order to notify that STA 1 and STA 3 wake up to the Transmitter, as shown in FIG. 17, STA 1 and STA 3 transmit a PS-Poll and receive data. After STA 2 and STA 4 receive the TIM Broadcast, STA 2 and STA 4 turn off WLAN and wait for receiving a WUR packet.

### Third Embodiment—Wake-Up According to a Trigger Frame after Receiving WUP

According this embodiment, after a WUR packet is transmitted, instead of the TIM transmission (e.g., TIM broadcast frame), a Trigger frame for polling PS-Poll may be transmitted.

FIG. 18 is a diagram illustrating an example of receiving a Trigger frame through WLAN after receiving a WUP according to an embodiment of the present invention.

In the example shown in FIG. 18, STAs (STA 1 to STA 4) belonged to Group ID 1 turn on WLAN after receiving a WUP. STAs 1 and 3 triggered in the Trigger frame transmitted thereafter inform that STAs 1 and 3 are awakened through a region allocated in the Trigger frame. For this, in the above example, STAs 1 and 3 transmit a PS-Poll to the allocated region.

### Fourth Embodiment—Transmit TIM and Trigger Frame Together Through WLAN

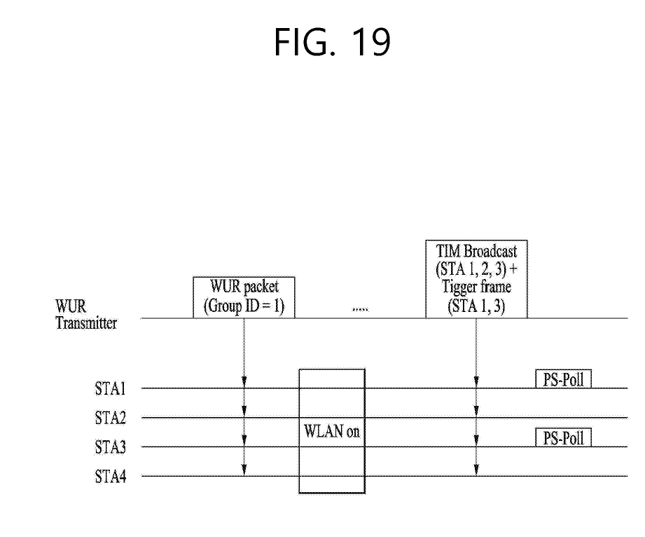

FIG. 19 is a diagram illustrating the case that TIM information and a Trigger frame are transmitted together through WLAN after receiving a WUP according to an embodiment of the present invention.

In this embodiment, STAs (STA 1 to STA 4) belonged to Group ID 1 turn on WLAN by receiving a WUR packet. STAs 1 and 3 triggered in TIM broadcast+Trigger frame transmitted thereafter inform that STAs 1 and 3 are awakened through a region allocated in the Trigger frame. For this, in the above example, STAs 1 and 3 transmit a PS-Poll to the allocated region. STA 3 which is indicated by the TIM broadcast but not triggered by the Trigger frame keeps WLAN in ON state and tries to transmit a PS-Poll after NAV indicated by the Trigger frame. STA 4 which is not indicated by the TIM broadcast turns OFF WLAN and waits for a WUR packet reception.

Group wake-up may be used for transmitting Multicast data. In this case, after a WUR packet for Group wake-up is transmitted, without receiving a wake-up acknowledge signal (e.g., PS-Poll) from a user equipment, the Multicast data may be transmitted on an appropriate time.

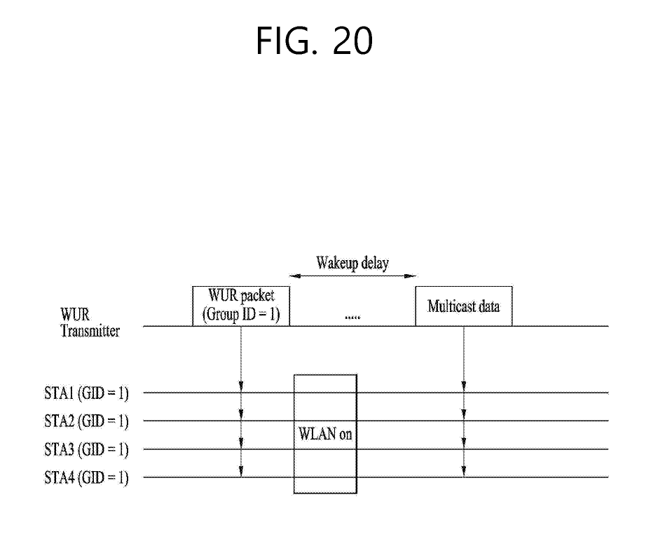

FIG. 20 is a diagram illustrating the case that Group wake-up is used when Multicast data is transmitted.

In the example shown in FIG. 20, when transmitting Multicast data to WUR STAs of the Group belonged to Group ID=1, a WUR transmitter (AP) transmits a WUR packet (Group ID=1) including Group ID=1. The STAs belonged to Group ID=1 that receives the WUR packet including Group ID=1 turn on WLAN. The WUR transmitter (AP), after transmitting the WUR packet without receiving a PS-Poll from the WUR STA, transmits Multicast data after a Wake up delay is lapsed.

In the above example, a Multicast address may be included instead of the Group ID. The same procedure is also used when Broadcast data, Beacon or DTIM data is transmitted.

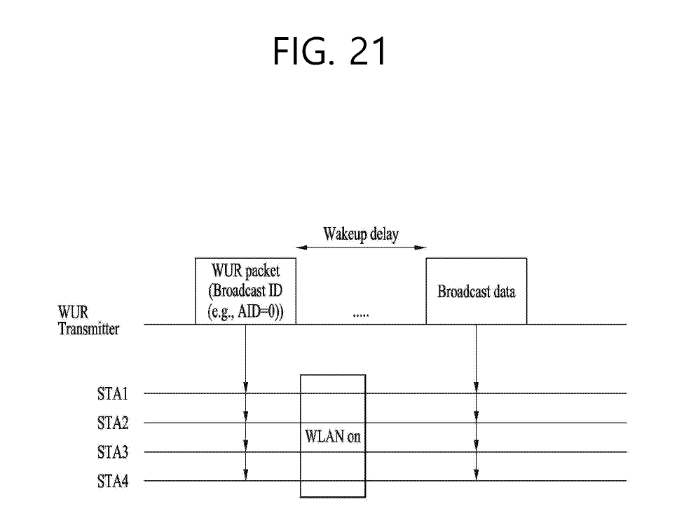

FIG. 21 illustrates an example that a WUP is transmitted using Broadcast ID according to an embodiment of the present invention.

In the example of FIG. 21, when a WUR transmitter transmits Broadcast data (e.g., Beacon, data for DTIM), the WUR transmitter may transmit a WUR packet including a Broadcast ID. The STA that receives the WUR packet including the Broadcast ID turns on WLAN, and waits for the Broadcast data to be transmitted from the AP (WUR transmitter). After transmitting the WUR packet, the WUR transmitter that transmits the WUR packet for Broadcast does not receive a wakeup acknowledge signal (e.g., PS-Poll) from the STA but transmits the Broadcast data to STAs.

Structure of TIM

Hereinafter, the TIM structure used for Wake-Up procedure in the above description is described in detail. The description below assumes that case that TIM is included in a WUP for the convenience of description, but does not exclude the case that the TIM is transmitted through WLAN.

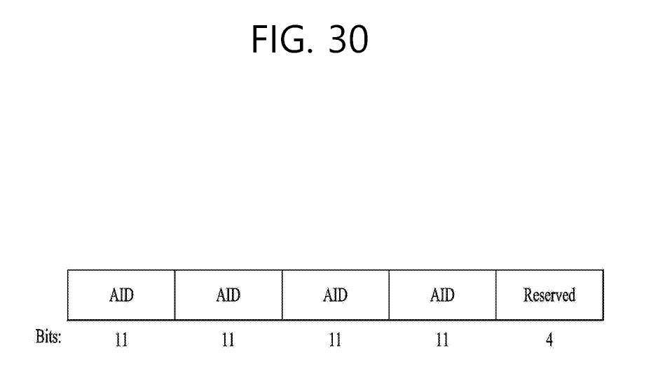

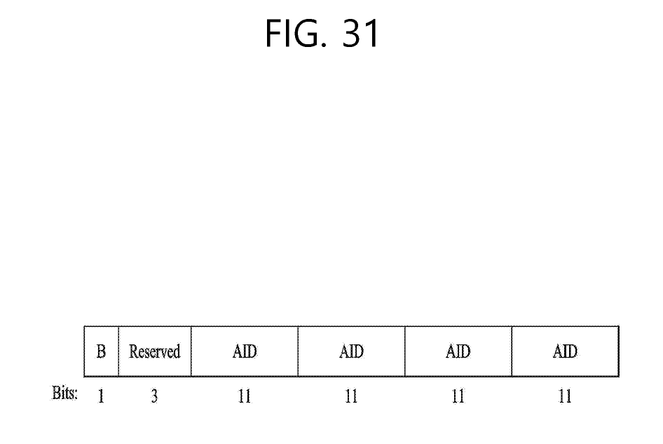

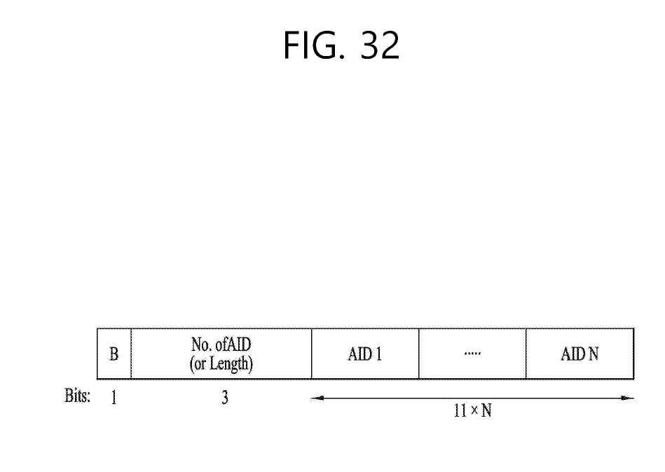

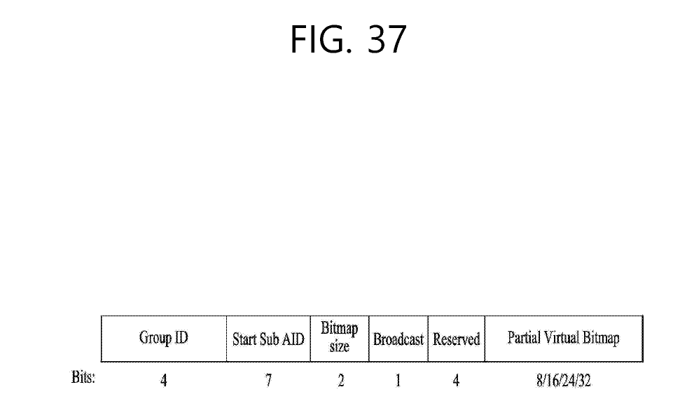

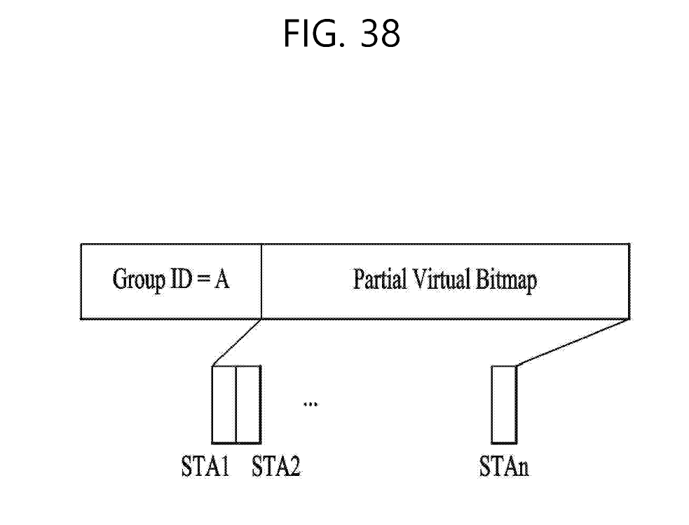

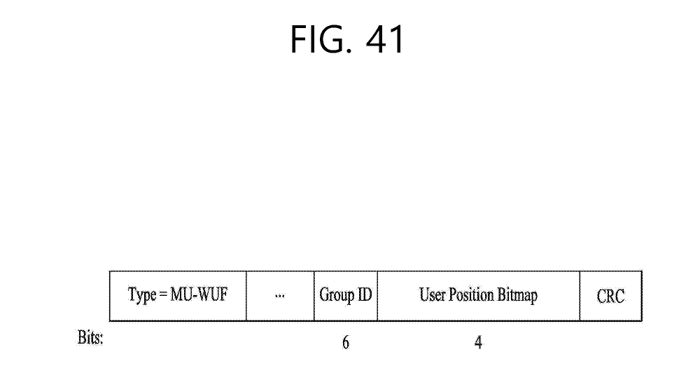

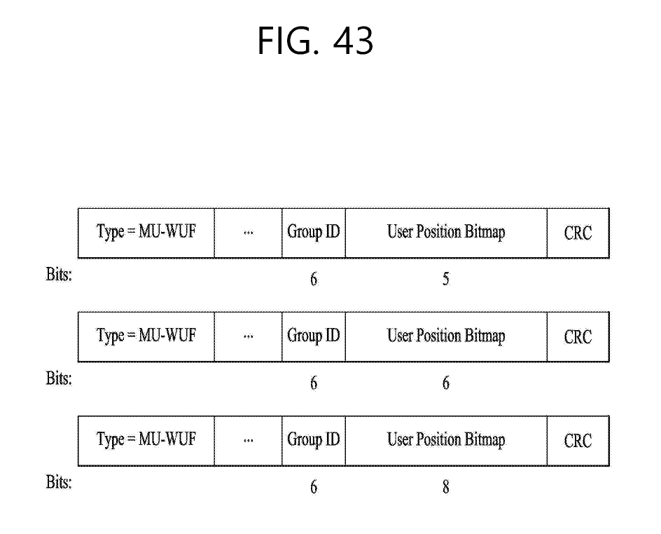

In addition, as described above, the fact that the TIM information is included in a Wake-up packet (WUP) is indicated by Frame Type/Sub-Type field located at the very front or indicates that the TIM is included in a part of a WUP when a Receiver ID part has a special value. For example, when the fact is indicated by Type field, the TIM may be included in the Receiver ID part, and when the fact that the TIM is indicated by the Receiver ID part, the TIM structure may be included in a specific field subsequent to the Receiver ID part or a MAC Payload part. The TIM structure may include one or more of several types below. In the case that one or more TIM structures included in a WUP, the type of TIM which is included may be indicated by a Frame type field or a TIM type field. As another method, different TIM structures may be indicated by different special values of the Receiver ID. As still another method, a special value of the Receiver ID indicates the TIM (i.e., Multiple STA ID information), and the first field of the TIM structure indicates a TIM type. For example, TIM Type=0 indicates Group ID+STA Position Bitmap structure (e.g., FIG. 37, FIG. 38, FIG. 41 and FIG. 43), and TIM Type=1 indicates STA ID list (e.g., the structure of one of FIG. 30, FIG. 31 and FIG. 32).

Type 1

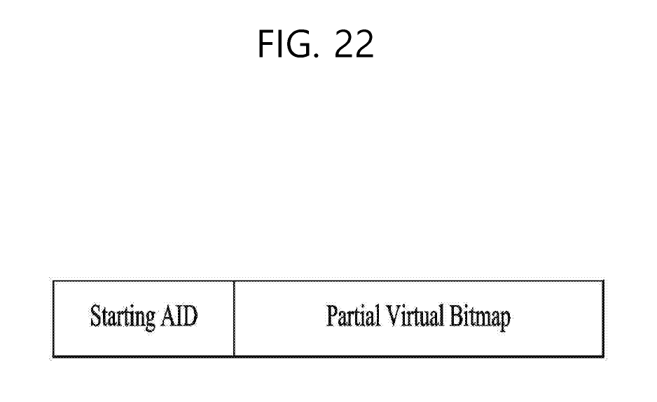

FIG. 22 is a diagram illustrating the TIM structure according to an embodiment of the present invention.

When the fact that a WUR packet includes TIM is indicated by the WUR packet, the TIM format having ‘Starting AID+Virtual Bitmap’ structure shown in FIG. 22 may be included. It may be indicated by a Frame Type (specific frame type value), a specific receiver address/ID whether the WUR TIM is included.

In FIG. 22, the Starting AID shows the AID for the first STA among the wake up indicated STAs when a Bitmap is constructed in an ascending order.

The Partial Virtual Bitmap indicates wake up indicated STAs and each bit corresponds to each AID in an ascending order from the Starting AID.

The Partial Virtual Bitmap has a fixed size of a byte unit such as 1 byte, 2 bytes, 3 bytes, 4 bytes, and the like.

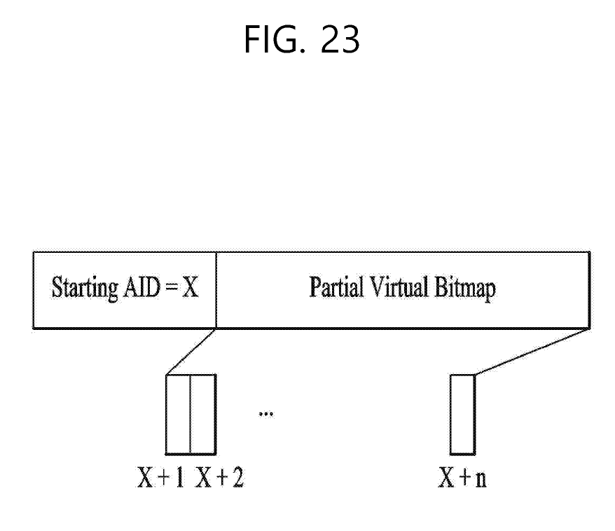

FIG. 23 illustrates an example that a size of the Partial Virtual Bitmap is 2 bytes (16 bits) in FIG. 22.

Depending on an embodiment, total information may be fixed in a unit of 2, 3 or 4 bytes.

As shown in FIG. 23, when the Starting AID is X, the first bit of the Bitmap indicates the STA that has an ID of X+1, and the subsequent bits indicate the STAs indicated by consecutive IDs (e.g., X+2, X+3, X+4, X+n).

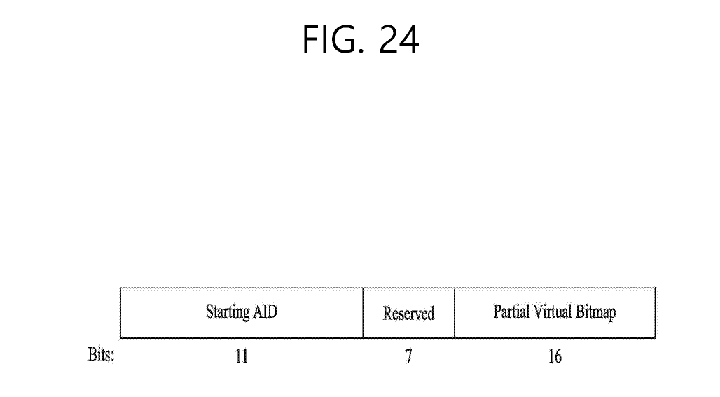

FIGS. 24 to 27 are diagrams illustrating a size predicted in the structure of FIG. 22.

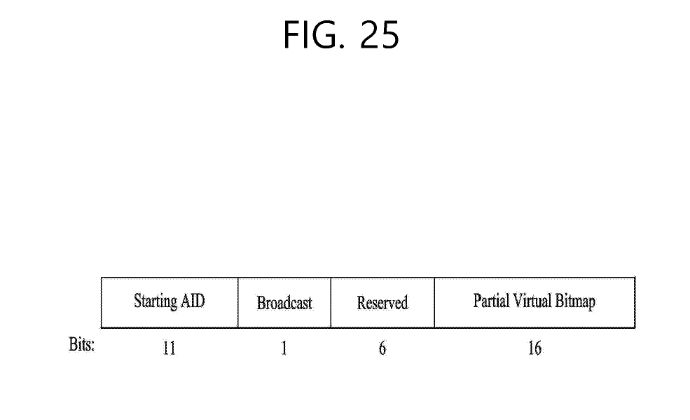

As shown in FIG. 25, whether there is a Broadcast frame transmission may be included.

Broadcast=1 indicates that there is a Broadcast frame transmission, after waking up.

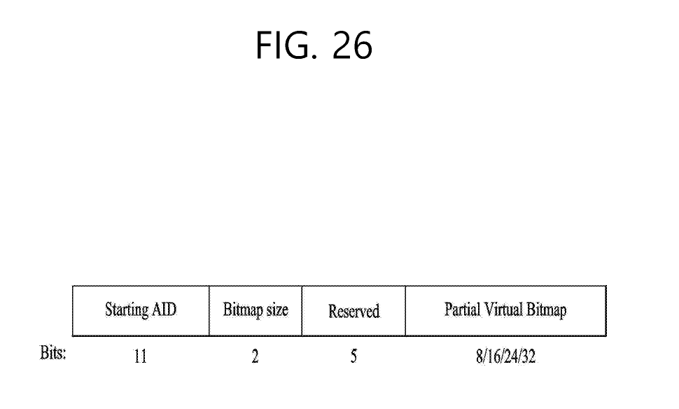

A size of Partial Virtual Bitmap may be varied as shown in FIG. 26.

Bitmap Size: This indicates a size of Partial Virtual Bitmap. In the above example, a size of the field is 2 bits, and each index indicates a Bitmap size of 8, 16, 24 and 32 bits, respectively, as represented in the following example. A size of the field and each index value may have different values.
0: 8 bits
1: 16 bits
2: 24 bits
3: 32 bits

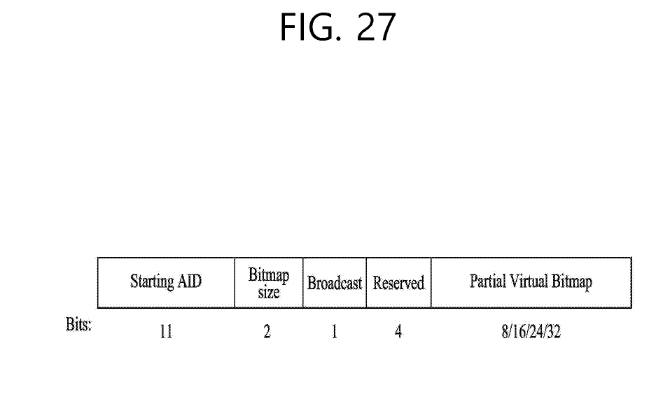

Meanwhile, as shown in FIG. 27, whether there is a Broadcast frame transmission may be included.

Broadcast: This indicates whether there is a Broadcast transmission.

The AID set as 0 indicates Broadcast, and all of the STAs that wake up based on AID=0 wait for a broadcast traffic.

In the embodiment, for the easy description, it is exemplified that an AID size is 11 bits, but it may also be described by defining that an AID size is greater than 11 bits (e.g., 12 bits) or smaller (e.g., Partial AID (9 bits), 6 bits partial AID), and the like.

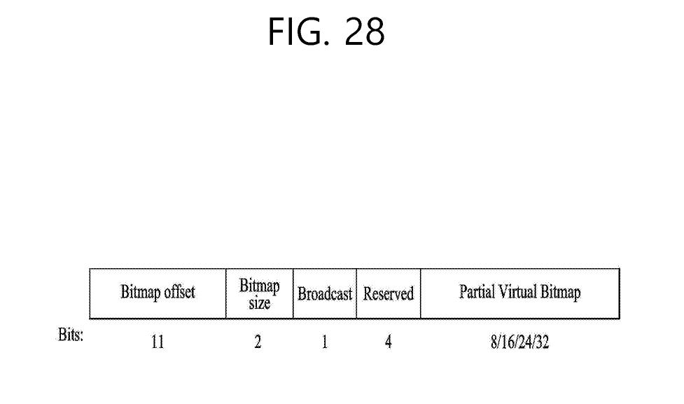

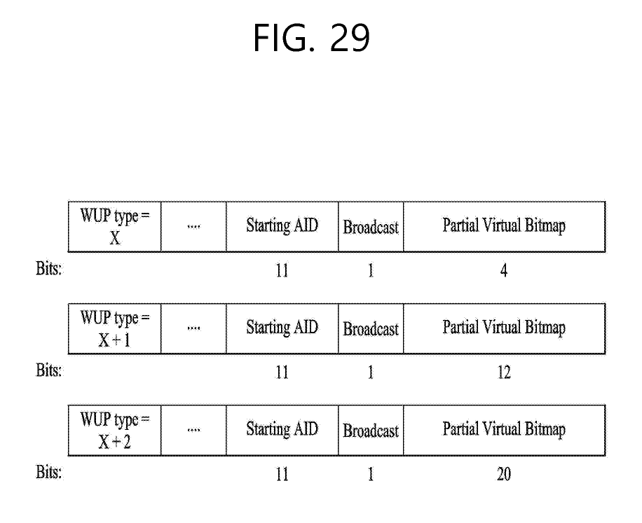

FIGS. 28 and 29 illustrate modified examples of other embodiments of the present invention.

FIG. 28 illustrates an example that the Starting AID described above is used with other term, Bitmap offset.

Bitmap size information may be indicated by a frame type. FIG. 29 shows an example for it.

WUP type=x indicates that the TIM (Starting AID+(Broadcast)+Virtual Bitmap) is total 2 bytes, and WUP type=x+1 indicates that the TIM is 3 bytes. And, WUP type=x+1 indicates that the TIM is 4 bytes.

The Broadcast field may be omitted.

Sizes of the Starting AID and the Partial Virtual Bitmap may be differently defined.

Type 2: Multiple AIDs Based TIM Structure

Several AIDs may be included in the TIM.

FIG. 30 illustrates a Fixed TIM structure including 4 AIDs according to an embodiment of the present invention.

The AID set as 0 indicates Broadcast, and all of the STAs that wake up based on AID=0 wait for a broadcast traffic. In the case that the AID is set as a special value (e.g., all 1s), it is indicated that the corresponding AID is an invalid AID.

FIGS. 31 to 34 illustrate modified examples of FIG. 30.

As shown in FIG. 31, the number of AIDs may be changeably configured, and it may be indicated by 1 bit indication whether the Broadcast is included as defined in Type 1 described above.

B (Broadcast): This set as 1, when a transmission for Broadcast frame/traffic (e.g., DTIM traffic, Group addressed traffic, etc.) is generated.

Meanwhile, as shown in FIG. 32, the number of AIDs may be changeably configured.

Number of AID (No. of AID) indicates the number of AIDs which is included, and the AIDs as much as the number comes thereafter.

Instead of the Number of AID, Length (bits or bytes) information may be included.

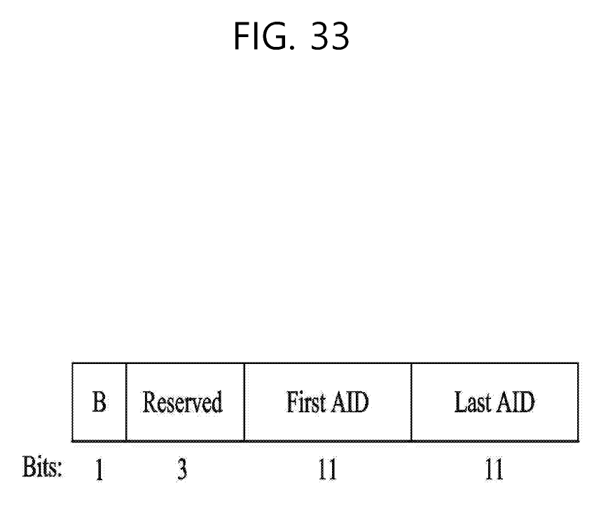

When the STAs for consecutive AIDs are awakened, as shown in FIG. 33, the consecutive AIDs may be indicated by using the First AID (or Start AID) and the Last AID (End AID) information.

Including the First AID and the Last AID, all of the STAs located in two AIDs may become receivers of TIM.

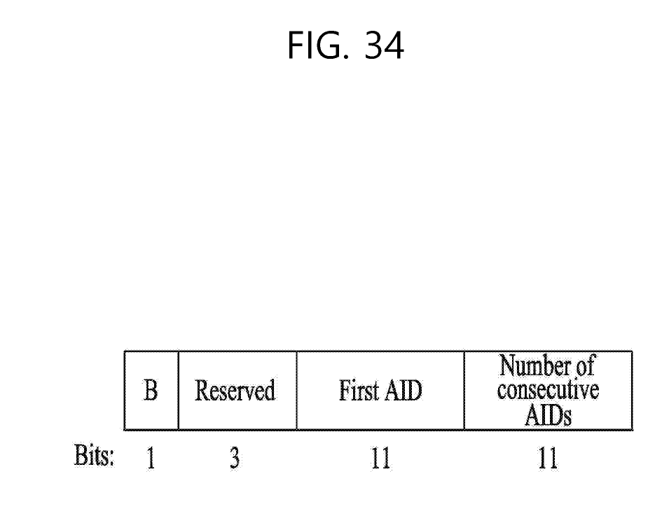

Instead of the Last AID, as shown in FIG. 34, Number of consecutive AIDs information may be included.

The Number of consecutive AIDs indicates the number of consecutive AIDs indicated in TIM. For example, in the case that the First AID is ‘A’ and the Number of consecutive AIDs is 3, the STAs corresponding to AID=A, A+1 and A+2 are indicated, and the corresponding STAs perform the wake up operation.

Type 3: Hierarchical Multiple AIDs Based TIM Structure

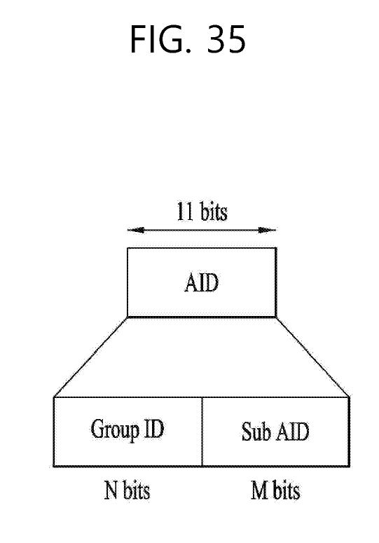

FIG. 35 is a diagram illustrating an example that an AID is hierarchically configured according to an embodiment of the present invention.

In the example shown in FIG. 35, MSB M bits among AID 11 bits indicate a Group. LSB M bits indicate a Sub AID.

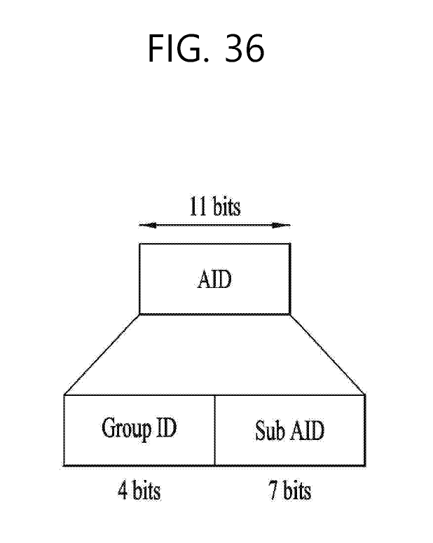

FIG. 36 is a particular example of FIG. 35, and illustrates an example that N=4 and M=7.

Meanwhile, overhead of AID may be reduced by including a Group ID in TIM.

FIGS. 37 and 38 illustrate an example that the TIM structure defined in FIG. 35 is shown in Group ID+sub AID form.

The example is just an example, and sizes of the Group ID and a Start sub AID may be changed, and may also be configured with Group ID+Bitmap without Start sub AID information. FIG. 38 shows an example for the case.

Each bit of the Bitmap indicates information to which the STAs which are belonged to the group are mapped. In the above example, STA 1 is allocated with ID 1 in the group, STA 2 is allocated with ID 2, and STA n is allocated with ID n.

The size of Group ID+Bitmap may be indicated by a frame type as below.

WUR frame type=x: Total length=2 bytes

WUR frame type=x+1: Total length=3 bytes

WUR frame type=x+2: Total length=4 bytes

WUR frame type=x+2: Total length=bytes

The above is just an example, and may be determined with different size.

The method of using a Group ID as such may be defined by Group ID management operation (subclause 11.41 in IEEE802.11-2016) defined in the conventional VHT.

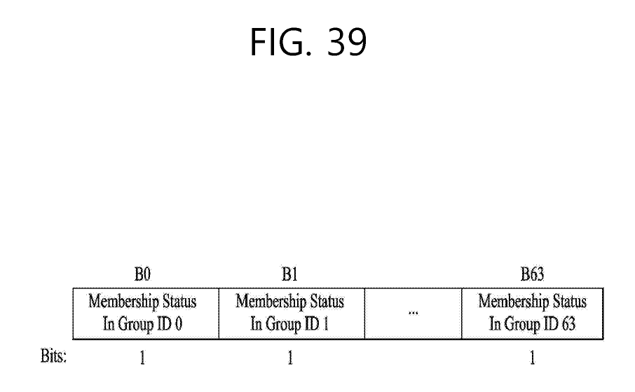

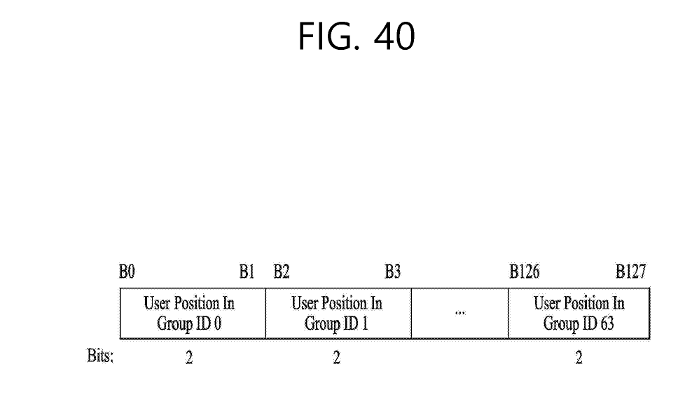

FIG. 39 is a diagram illustrating a membership state array field according to an embodiment of the present invention, and FIG. 40 is a diagram illustrating a user location array field.

For example, in the case that a user equipment having a WUR capability has the Multi-user wake-up capability, an AP allocates a Group ID to the corresponding user equipment by using the methods defined in 11.41 Group ID management operation. The user equipment may know the group to which the user equipment is belonged using the Membership Status Array field and the location of an STA in each group which is allocated using the User Position Array field.

After a Group ID is allocated, when entering a WUR mode, when transmitting the MU Wake-up frame, the AP transmits it with the Group ID and the User Position bitmap.

FIGS. 41 to 43 are diagrams illustrating examples of transmitting a WUP with a Group ID and a User Position Bitmap being included according to an embodiment of the present invention.

In the case that a Group ID is allocated by using the Membership Status Array field and the User Position Array field which have been used in 11ac without any change, the Group ID of 6 bits and the User Position Bitmap of 4 bits are included in the MU wake-up frame.

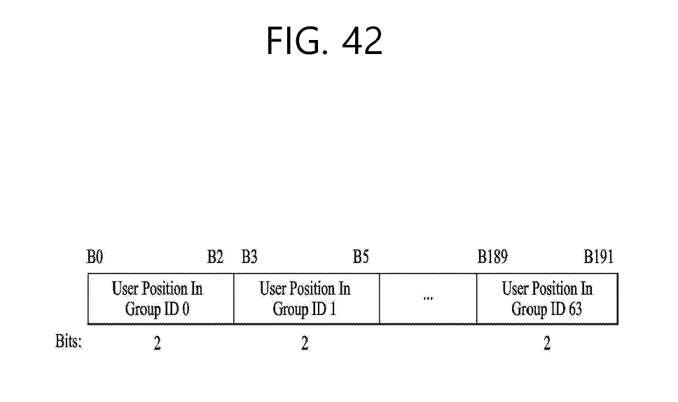

Each User Position of the User Position Array field may be defined by the size to 3 bits. FIG. 42 shows the case of a User Position having a changed bit size as such.

When a User Position is configured with 3 bits, in the MU WUR frame, the User Position Bitmap may be configured with maximum 8 bits. A preferable size of the User Position Bitmap may be configured with one of 5, 6 and 8 bits. FIG. 43 shows the example for the case. However, a size of the Bitmap may be configured with greater than 8 bits.

Like the Group ID allocation method of 11ac, an AP may be allocated with one or more STAs in the same User Position, and a single STA may allocates one or more Group IDs. In a particular case, an AP may allocate only one STA in a User Position.

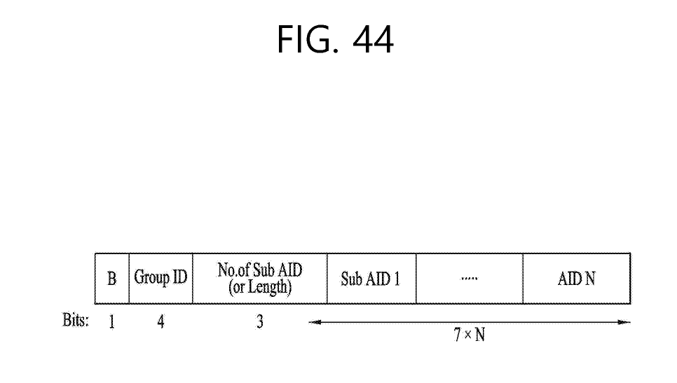

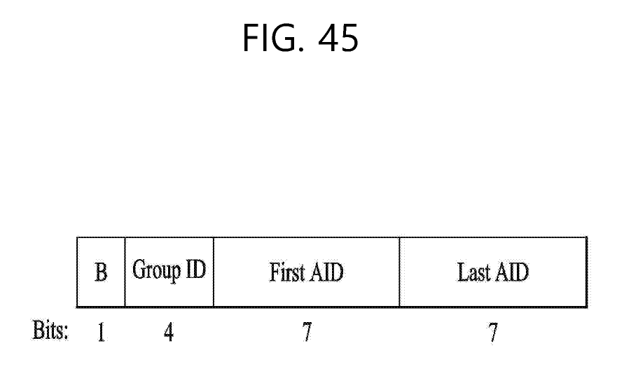

FIGS. 44 and 45 are diagrams illustrating Group ID structures according to an embodiment of the present invention.

As shown in FIG. 44, a Group ID indicates a group of AID, and a Start Sub AID indicates a Sub AID which is started in a Group. Through the subsequent Partial Virtual Bitmap, it may be known the STAs corresponding to a certain AID to be awakened using the Start Sub AID.

Since the Group ID is included, instead of the AID, the number of Sub AIDs (7 bits size) is included as much as that of indicated by the Number of Sub AIDs.

Among the STAs belonged to the group indicated by the Group ID, the STAs positioned between two AIDs including the First AID and the Last AID may be indicated, and FIG. 45 shows such a case.

An AP (WUR transmitter) may allocate a WUR ID to a WUR receiver. The WUR ID represents the ID that distinguishes a WUR STA when the WUR STA operates in a WUR mode (WUR ON). The WUR ID may be allocated instead of the AID, and allocated in an association procedure, or the WUR ID may be allocated when the WUR STA enters the WUR mode.

A WUR packet may be configured by using TIM information based on a WUR ID only for the WUR STA which is allocated with the WUR ID. That is, when the AP wakes up the STAs having the WUR ID capability, the AP may wake up the STAs by transmitting the WUR including the TIM information configured based on the WUR ID.

Type 4: Block Bitmap Type

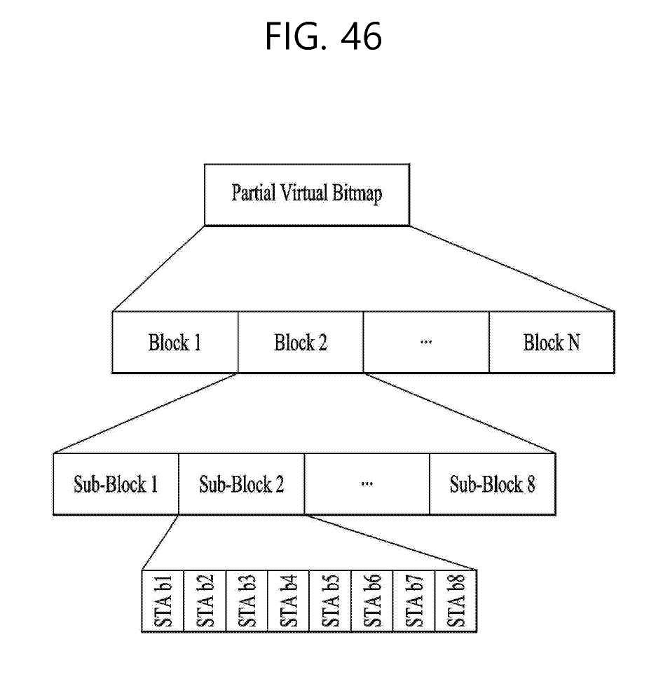

FIG. 46 is a diagram illustrating the case of having a Block Bitmap type according to an embodiment of the present invention.

A Partial Virtual Bitmap may be divided into several Blocks, and a single Block may include several Sub Blocks, and a single Sub Block may be configured with 8 bits.

In the example of FIG. 46, the Partial Virtual Bitmap is configured with N Blocks, and a single Block is configured with 8. Sub Blocks, and a single Sub Block includes 8 STAs.

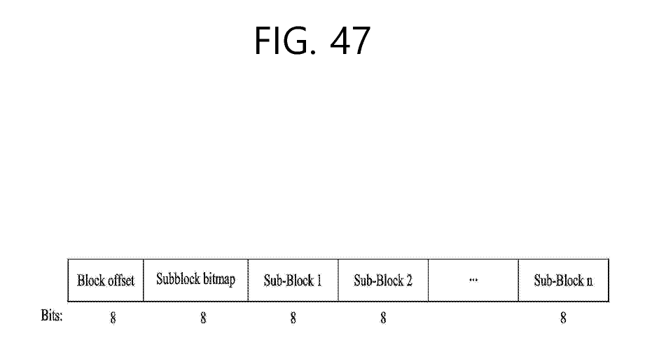

FIGS. 47 to 49 illustrate modified examples of FIG. 46.

In the Block Bitmap structure shown in FIG. 46, in order to inform the Bitmap information, a Sub Block Bitmap per Block is included in the TIM, and in order to inform which Block is related, a Block offset is included. FIG. 47 shows the example for the case.

In FIG. 47, as much as the number n masked by 1 in the Subblock bitmap, a Sub-Block of 1 byte size follows.

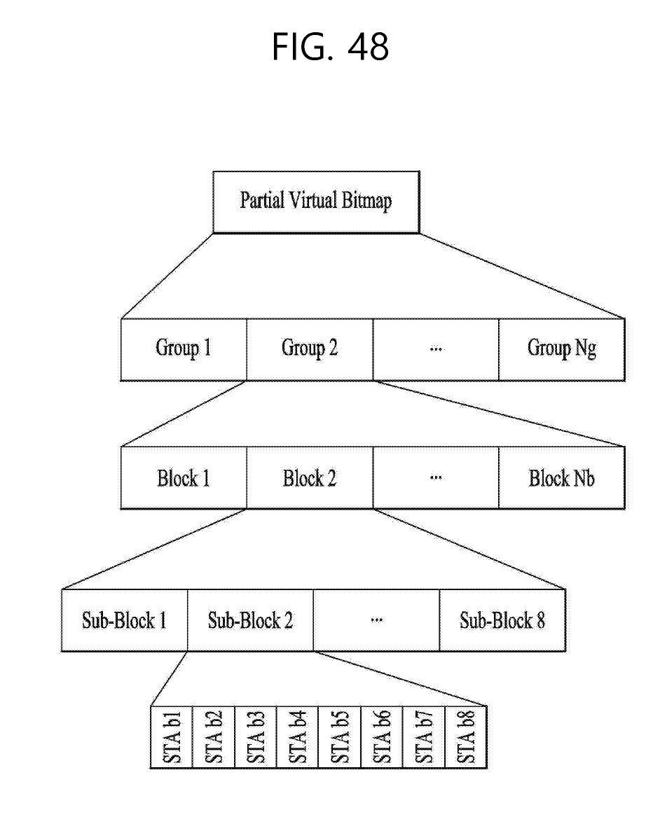

The Partial Virtual Bitmap may be divided into several groups (pages), and each page may be configured with several blocks. FIG. 48 shows the example for the case.

In FIG. 48, it is configured with Ng groups, and each group is configured with Nb blocks. Each block includes maximum 8 sub blocks, and each sub block includes 8 STAs.

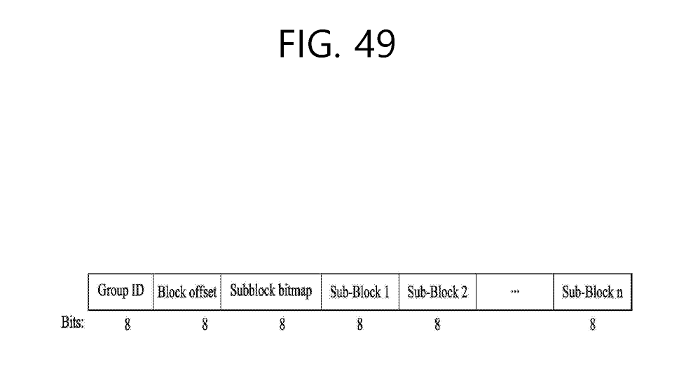

FIG. 49 shows another example.

In FIG. 49, the TIM includes a Group ID indicating a group of TIM related to the TIM information, a block offset indicating an order of the block in the group, and a subblock bitmap indicating a sub block related to the TIM information. In the subblock bitmap, the sub-blocks corresponding to bits as much as the number of bits set as 1 is included, and each bit in the sub-block indicates the STA corresponding to each bit. The bit corresponding to the STA indicated by the TIM is set as 1.

Type: AID Differential Values Type

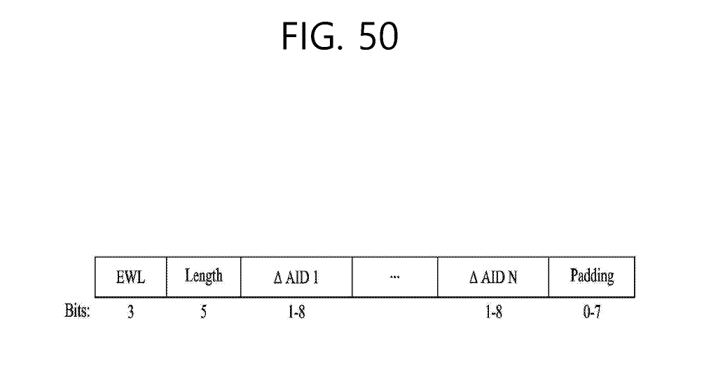

FIG. 50 is a diagram illustrating the case that an AID differential value is included instead of the AID according to an embodiment of the present invention.

In FIG. 50, EWL is a short term of Encoded word length, and indicates a length of a delta AID. The Length indicates a length including the delta AIDs and a padding.

An AP arranges all AIDi (i=1, 2, . . . , n) in an ascending order (AID1<AID 2<AID3< . . . <AIDn), and calculates the delta AID.

Delta AID 1=AID 1−(the first AID in a corresponding block)

Delta AIDi=AIDi−AIDi−1, i=2, 3 . . . n

WL indicates a bit size of the smallest number that is able to represent the greatest delta AIDi, and EWL is set as WL−1. For (n) delta AID, WL Xn bits are requested. The bit size may be equal to or smaller than 248 (=31 (5 bits length)*8).

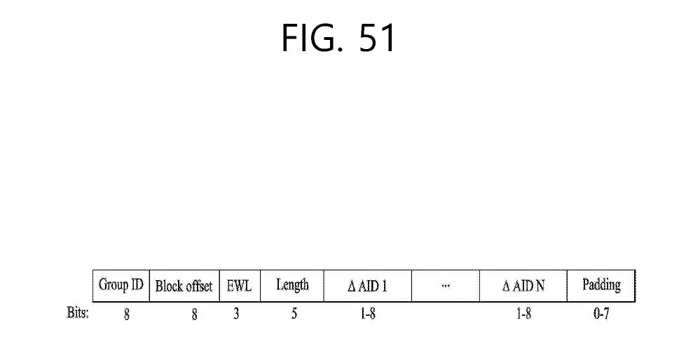

FIG. 51 illustrates a modified example of FIG. 50.

As shown in FIG. 51, a Group ID, a Block offset, and the like may be included.

Type 6: Single AID Type

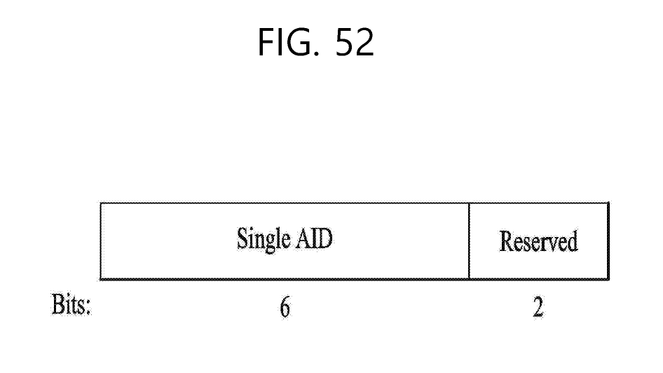

FIG. 52 is a diagram illustrating the case that only a single AID is included in a corresponding Block according to an embodiment of the present invention.

With respect to the types defined above, one or more types may be supported, and information for a type which is supported may also be included.

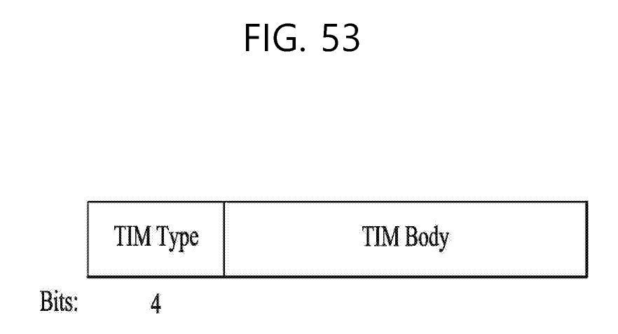

FIG. 53 is a diagram for describing the case that one or more types are supported according to an embodiment of the present invention.

Several types 1 to 6 which are defined above may be differently included in a TIM body depending on a TIM Type value.
Type=0: Start AID+Virtual bitmap
Type=1: Multiple AIDs based TIM
Type=2: Hierarchical Multiple AIDs
Type=3: Block Bitmap
Type=4: Single AID
Type=5: AID differential value
Type=6: Inverse+Multiple AIDs based TIM
Type=7: Inverse+Single AID
Type=8: Inverse+Block Bitmap
Type=9: Inverse+AID differential value

Types 6, 7, 8 and 9 indicate Inverse. Type 7 indicates that the remaining STAs are awakened except the STA indicated by a Single AID in the corresponding Block. Type 6 indicates that the remaining STAs are awakened except the STAs indicated by Multiple AIDs. Types 8 and 9 also indicates that the remaining STAs are awakened except the STAs indicated by Bitmap and differential value.

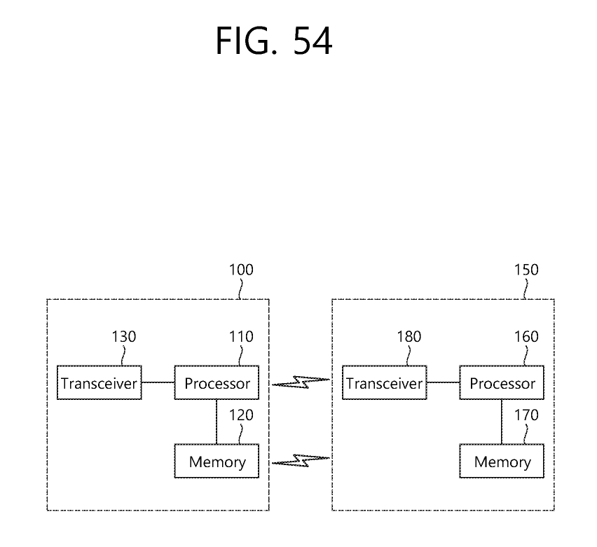

FIG. 54 is a block diagram for an exemplary configuration of an AP device (or a base station device) and an STA device (or a user equipment device) according to an embodiment of the present invention.

An AP 100 may include a processor 110, a memory 120, and a transceiver 130. An STA 150 may include a processor 160, a memory 170, and a transceiver 180.

The transceiver 130/180 may transmit/receive a radio signal, for example, implement a physical layer according to IEEE 802 system. The processor 110/160 is connected with the transceiver 130/180 and may implement a physical layer and/or a MAC layer according to IEEE 802 system. The processor 110/160 may be configured to perform an operation according to one or two or more combinations of various embodiments of the present invention described above. In addition, a module for implementing operations of the AP and the STA according to the various embodiments of the present invention may be stored in the memory 120/170 and the module may be executed by the processor 110/160. The memory 120/170 may be included in the processor 110/160 or installed in the outside of the processor 110/160, and connected with the processor 110/160 via a well-known means.

The description of the AP 100 and the STA 150 may be respectively applied to a base station and a user equipment in a different wireless communication system (e.g., LTE/LTE-A system).

The detailed configurations of the AP and the STA as described above may be implemented such that the above-described embodiments may be independently applied or two or more thereof may be simultaneously applied, and description of redundant parts is omitted for clarity.

The detailed description of the preferred embodiments of the present invention has been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. Accordingly, the invention should not be limited to the embodiments described herein, but should be accorded the broadest scope consistent with the principles and novel features disclosed herein. It will be apparent that, although the preferred embodiments have been shown and described above, the present specification is not limited to the above-described specific embodiments and various modifications and variations can be made by those skilled in the art to which the present invention pertains without departing from the gist of the appended claims. Thus, it is intended that the modifications and variations should not be understood independently of the technical spirit or prospect of the present specification.

In addition, this document describes the product invention and the method invention and descriptions of both the inventions may be complementarily applied as needed.

The embodiments of the present invention described above may be applied to various wireless communication systems such as IEEE 802.11 system.

1. A method for supporting a power consumption save operation of a first wireless device including a Wake-Up Receiver (WUR) and a Wireless Local Area Network (WLAN) transceiver in a wireless LAN system, the method comprising:
receiving, by the first wireless device, a Wake-Up Packet (WUP) including a group-based identifier from a second wireless device,
wherein the WUP is received based on the WUR while the WLAN transceiver is in an OFF state,
wherein the WUP is addressed to a plurality of stations (STAs) identified by the group-based identifier, and
wherein the first wireless device is related to one of the plurality of STAs;
receiving, by the first wireless device, a trigger frame soliciting one or more uplink transmissions from the plurality of STAs after the WLAN transceiver transitions from the OFF state to an ON state based on the WUP,
wherein the trigger frame is received based on the WLAN transceiver; and
transmitting, by the first wireless device, a response frame to the second wireless device in response to the trigger frame.

2. The method of claim 1, wherein the WUP further includes a receiver identifier (ID) or an address field and a payload field.

3. The method of claim 1, wherein the trigger frame includes identification information related to one or more STAs for the one or more uplink transmissions and uplink resource information related to the one or more STAs for the one or more uplink transmissions.

4-9. (canceled)

10. The method of claim 1, wherein the first wireless device receives a frame including a Membership Status Array field related to a group to which the first wireless device belongs and a User Position Array field related to a position of the first wireless device in the group from an Access Point (AP), and
wherein the group-based identifier is identified based on the Membership Status Array field and the User Position Array field.

11. A first wireless device supporting a power save operation in a wireless LAN system, the first wireless device comprising:
one or more antennas;
a Wake-UP Receiver (WUR) connected to the antenna;
a Wireless Local Area Network (WLAN) transceiver connected to the antenna; and
a processor for controlling the WUR and the WLAN transceiver,
wherein the processor is configured to:
receive a Wake-Up Packet (WUP) including a group-based identifier from a second wireless device,
wherein the WUP is received based on the WUR while the WLAN transceiver is in an OFF state,
wherein the WUP is addressed to a plurality of stations (STAs) identified by the group-based identifier, and
wherein the first wireless device is related to one of the plurality of STAs;
receive a trigger frame soliciting one or more uplink transmissions from the plurality of STAs after the WLAN transceiver transitions from the OFF state to an ON state based on the WUP,
wherein the trigger frame is received based on the WLAN transceiver, and
transmit a response frame to the second wireless device in response to the trigger frame.

12-15. (canceled)

16. The method of claim 11, wherein the WUP further includes a receiver identifier (ID) or an address field and a payload field.

17. The method of claim 11, wherein the trigger frame includes identification information related to one or more STAs for the one or more uplink transmissions and uplink resource information related to the one or more STAs for the one or more uplink transmissions.

18. The method of claim 11, wherein the first wireless device receives a frame including a Membership Status Array field related to a group to which the first wireless device belongs and a User Position Array field related to a position of the first wireless device in the group from an Access Point (AP), and
wherein the group-based identifier is identified based on the Membership Status Array field and the User Position Array field.
